(19) United States
(12) Patent Application Publication
(10) Pub. No.: US 2006/0037657 A1
(43) Pub. Date: Feb. 23, 2006

(54) Method and apparatus for controlling minute amount of fluid

(76) Inventors: Yuichi Shibata, Hitachi-shi (JP); Takeshi Oshikubo, Mito-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/525,367

(22) PCT Filed: Aug. 12, 2003
(86) PCT No.: PCT/JP03/10272

§ 371 Date: Feb. 23, 2005

(30) Foreign Application Priority Data
Aug. 23, 2002 (JP) 2002-243730

(51) Int. Cl. F15C 1/04

(52) U.S. Cl. 137/827

(57) ABSTRACT

The present invention relates to a controlling method and a controlling apparatus wherein, in a microscopic flow passage such as a micro flow passage or a nano flow passage, an inhalation of a sample microscopic fluid and a flow amount control and a quantity amount control of the sample microscopic fluid can be carried out. A driving microscopic fluid, which is putted into the microscopic flow passage such as the micro flow passage or the nano flow passage and reacts to an electric field or a magnetic field, is moved by changing the electric field or the magnetic field from an outer side and by positioning it, thereby the inhalation and the flow amount of the sample microscopic fluid is controlled.

### TECHNICAL FIELD

The present invention relates to a microscopic fluid controlling method and a microscopic fluid controlling apparatus, in particularly relates to a microscopic fluid controlling method and a microscopic fluid controlling apparatus in which, in a microscopic flow passages such as a micro flow passage or a nano flow passage, using a fluid having a microscopic amount (a driving microscopic fluid), which reacts to an electric field or a magnetic field, a flow amount control and a quantity amount control of a microscopic fluid (a sample microscopic fluid) having a micro-little order or a nano-little order are carried out.

### BACKGROUND TECHNIQUE

In a conventional microscopic fluid controlling apparatus, using a microscopic amount controlling valve and a micro-pump etc., a flow amount control of a microscopic fluid is carried out. Further, in a conventional microscopic fluid controlling method, using a capillary in a capillary tube, a liquid having a microscopic amount is moved. Further, as another conventional microscopic fluid controlling method, there is a method for a dividing microscopic fluid by putting a gaseous body into a liquid having a microscopic amount in a microscopic flow passage.

In recently, as shown in Japanese patent laid-open publication No. 2001-132861 specification, in a microscopic fluid controlling method, there is a method using a microscopic valve in which a colloidal liquid, in which ferromagnetism supper microscopic particles having an electric polarization property and diamagnetism supper microscopic particles are included in a microscopic capsule. However, with the above stated method, since a controlling mechanism for controlling the microscopic fluid is complicated, a manufacturing and a control of the microscopic fluid become difficult.

Further, in the conventional microscopic fluid controlling apparatus, when a liquid having a microscopic amount is flowed into a bioreactor or a chemical reactor, an inflow amount and a flow-out amount of the microscopic fluid are necessary to control accurately. As a passage tube for flowing into or flowing out the above stated microscopic fluid, a micro flow passage or a nano flow passage is employed and a flowing-into of the liquid and the gaseous body is carried out by using a microscopic amount controlling valve or a micro pump.

Accordingly, during a start time and during a stop time of the micro pump, since a difference in error of the flowing-into amount and the flowing-out amount of the microscopic fluid causes, the more acute control of the flowing-into amount and the flowing-out amount of the microscopic fluid is very difficult.

Further, in the control of the fluid having the microscopic amount in the micro flow passage or the nano flow passage, in the conventional microscopic fluid controlling method, since the difference in error of the microscopic fluid is big and the carrying-out of the control becomes hardly, in the conventional microscopic fluid controlling method, a main problem resides in that how carries out the flow amount control and the quantity amount control of the microscopic fluid.

To dissolve the above stated problems, an object of the present invention is to provide a microscopic fluid controlling method and a microscopic fluid controlling apparatus wherein an inhalation of a microscopic fluid into a microscopic flow passage such as a micro flow passage or a nano flow passage and a flow amount control and a quantity amount control of the microscopic fluid can be carried out.

### DISCLOSURE OF THE INVENTION

The present invention is to provide a microscopic fluid controlling method wherein the method comprises the steps of: moving a first microscopic fluid by changing an electric field or a magnetic field and by positioning the first microscopic fluid at a microscopic flow passage, inhaling a second microscopic fluid at the microscopic passage by succeeding the first microscopic fluid, and controlling the second microscopic fluid existed in the microscopic flow passage in respective of a move of the first microscopic fluid.

The present invention is to provide a microscopic fluid controlling apparatus wherein the apparatus comprises, a first microscopic fluid moving means for positioning and moving a first microscopic fluid in a microscopic flow passage, a second microscopic fluid inhaling means for inhaling a second microscopic fluid in the microscopic flow passage by succeeding the first microscopic fluid, and a controlling means for controlling the second microscopic fluid.

In the present invention, in a microscopic flow passage such as a micro flow passage or a nano flow passage, a driving microscopic fluid which reacts to an electric field or a magnetic field is putted into, in accordance with a move of the microscopic fluid a sample microscopic fluid is controlled to move in the microscopic flow passage and to position the microscopic fluid.

Further, to perform a quantity amount control of the sample microscopic fluid, a branch tube is provided to form the microscopic flow passage such as the micro flow passage or the nano flow passage, using a liquid or a gaseous body which is putted into the branch tube, the microscopic fluid, which reacts to the electric field or the magnetic field, is moved and the sample microscopic fluid is divided and, as a result, a more minute flow amount control and a more minute quantity amount control of the sample microscopic fluid are carried out.

Further, a heating portion is provided at an outer peripheral portion of the microscopic flow passage such as the micro flow passage or the nano flow passage, using the driving microscopic fluid which reacts to the electric field or the magnetic field, to the heating portion the sample microscopic fluid is moved and heated, then the sample microscopic fluid is separated and the flow amount of the sample microscopic fluid is controlled.

In particular, when a flow amount in responsive to a mass of the sample microscopic fluid having a different density is performed, the driving microscopic fluid, which reacts to the electric field or the magnetic field, is putted into the microscopic flow passage such as the micro flow passage or the nano flow passage, the driving microscopic fluid is installed to a rotary body, utilizing by combining a centrifugal force according to the rotation with the electric field or the magnetic field, then the driving microscopic fluid is moved. The sample microscopic fluid is flown into and is flown out, accordingly the blending and the separation of the sample microscopic fluid are carried out.

Further, an interior portion of the microscopic flow passage such as the micro flow passage or the nano flow passage and a vicinity of the micro flow passage are lyophobic processed, water repellent processed or waste oil processed, thereby an accuracy of the flow amount control of the sample microscopic fluid is heightened.

### BRIEF DESCRIPTION OF DRAWINGS

FIG. 1 is a basic conceptive cross-sectional view showing one carrying-out embodiment of a microscopic fluid controlling apparatus according to the present invention, and a cross-sectional view of the microscopic fluid controlling apparatus for a flow amount control of a magnetic fluid according to magnets, which are arranged at an outer peripheral portion of the microscopic flow passage.

FIG. 2 is a basic conceptive cross-sectional view showing one carrying-out embodiment of a microscopic fluid controlling apparatus according to the present invention, and a cross-sectional view of the microscopic fluid controlling apparatus for carrying out a flow amount control of a magnetic fluid according to plural electromagnets, which are arranged at an outer peripheral portion of the microscopic flow passage.

FIG. 3 is a cross-sectional view showing an inhaling embodiment of sample microscopic liquid in the microscopic fluid controlling apparatus according to the present invention.

FIG. 4 is a cross-sectional view showing a moving embodiment of the sample microscopic liquid in the microscopic fluid controlling apparatus according to the present invention.

FIG. 5 is a basic conceptive cross-sectional view showing one carrying-out embodiment of a microscopic fluid controlling apparatus according to the present invention having a liquid separating means or a gaseous separating means using a branch tube, and a cross-sectional view of the microscopic fluid controlling apparatus having a liquid separating means or a gaseous separating means using an T shape type branch tube.

FIG. 6 is a basic conceptive cross-sectional view showing one carrying-out embodiment of a microscopic fluid controlling apparatus according to the present invention having a liquid separating means or a gaseous separating means using a branch tube, and a cross-sectional view of the microscopic fluid controlling apparatus having a liquid separating means or a gaseous separating means using an T shape type branch tube.

FIG. 7 is a basic conceptive cross-sectional view showing one carrying-out embodiment of a microscopic fluid controlling apparatus according to the present invention for separating a sample microscopic fluid by providing a heating portion at an outer peripheral portion of a microscopic flow passage, and a cross-sectional view of the microscopic fluid controlling apparatus showing an embodiment in which the sample microscopic fluid moves in the heating portion.

FIG. 8 is a basic conceptive cross-sectional view showing one carrying-out embodiment of a microscopic fluid controlling apparatus according to the present invention to separate a sample microscopic fluid by providing a heating portion at an outer peripheral portion of a microscopic flow passage, and a cross-sectional view of the microscopic fluid controlling apparatus showing an embodiment in which a part of the sample microscopic fluid evaporates and separates in the heating portion.

FIG. 9 is a basic conceptive cross-sectional view showing one carrying-out embodiment of a microscopic fluid controlling apparatus according to the present invention to separate a sample microscopic fluid by providing a heating portion at an outer peripheral portion of a microscopic flow passage, and a cross-sectional view of the microscopic fluid controlling apparatus showing an embodiment in which a separated sample microscopic fluid moves further toward a downstream.

FIG. 10 is a cross-sectional view of one carrying-out embodiment of a microscopic fluid controlling apparatus according to the present invention by providing a microscopic flow passage on a rotary body and utilizing a centrifugal force and a magnetic force.

FIG. 11 is a cross-sectional view of a move of a microscopic fluid controlling apparatus according to the present invention by providing a microscopic flow passage on a rotary body and utilizing a centrifugal force and a magnetic force.

FIG. 12 is a basic conceptive cross-sectional view showing one carrying-out embodiment of a microscopic fluid controlling apparatus according to the present invention, and a partial cross-sectional perspective view of the microscopic fluid controlling apparatus for carrying out a flow amount control of a magnetic fluid by arranging plural magnets at an outer peripheral portion of a microscopic flow passage.

FIG. 13 is a basic conceptive cross-sectional view showing one carrying-out embodiment of a microscopic fluid controlling apparatus according to the present invention, and a perspective view of the microscopic fluid controlling apparatus for carrying out a flow amount control of a magnetic fluid by arranging plural electromagnets on a upper portion of a bio-chip having channels.

FIG. 14 is an upper face view showing a bio-chip having a specific shape channel used in a microscopic fluid controlling apparatus for carrying out a flow amount control of a magnetic fluid in the microscopic fluid controlling apparatus according to the present invention.

### BEST MODE EMBODIMENT FOR CARRYING OUT THE INVENTION

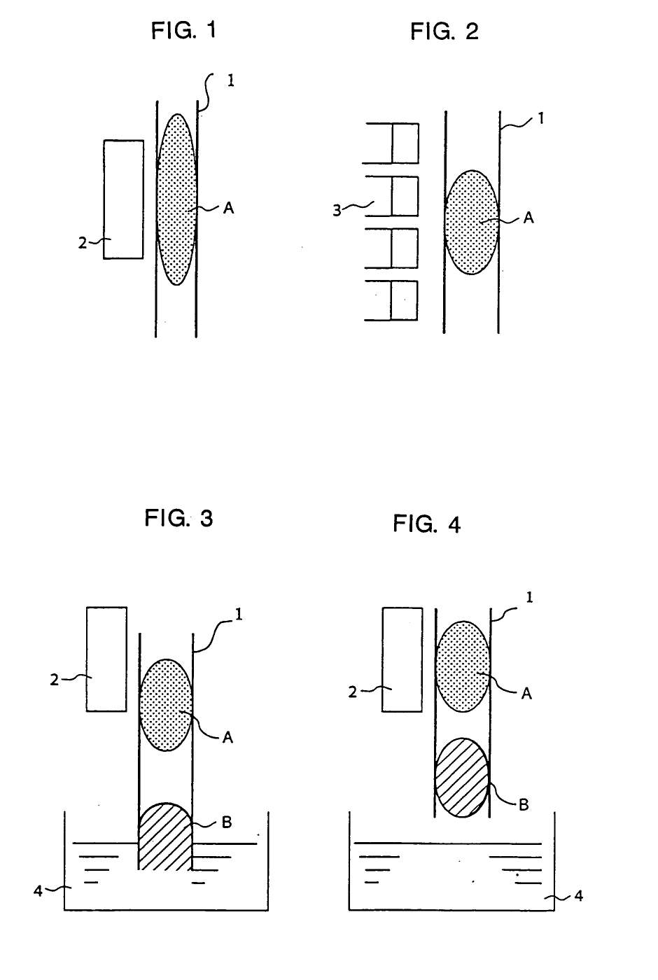

Hereinafter, on embodiment of the present invention will be explained in detail referring to the drawings. FIG. 1 shows one embodiment construction example of a microscopic fluid controlling apparatus according to the present invention. Into a microscopic flow passage 1, such as a micro flow passage or a nano flow passage, being a flow passage in which a microscopic fluid moves, an electric field fluid A being a fluid A (a driving microscopic fluid: a first microscopic fluid plug fluid), which reacts to an electric field, is poured.

This electric field fluid A is, for example, a ferro-fluid and oil (kerosene oil, light oil etc.) including iron powders. A magnet 2 is mounted on an outer peripheral portion of the microscopic flow passage 1 and controls the electric field fluid A according to an output thereof.

FIG. 2 shows another embodiment construction example of a microscopic fluid controlling apparatus according to the present invention. Into a microscopic flow passage 1, such as a micro flow passage or a nano flow passage, being a flow passage in which a microscopic fluid moves, an magnetic fluid A being a fluid A (a driving microscopic fluid: a first microscopic fluid plug fluid), which reacts to an electric field, is poured.

This magnetic fluid A is, for example, a ferro-fluid and oil (kerosene oil, light oil etc.) including iron powders. A magnet 2 is mounted on an outer peripheral portion of the microscopic flow passage 1 and controls the magnetic fluid A according to an output thereof.

In the microscopic fluid controlling apparatus shown in FIG. 1 or FIG. 2, to perform the control of the microscopic fluid A which reacts to the electric field or the magnetic field, there are two methods, for example, one method is that at a side, in which the microscopic flow passage 1 is fixed and the electric field and the magnetic field generate, namely when the electric field generating means or the magnetic field generating means is controlled and another method is that the generating means is fixed the microscopic fluid moves in the microscopic flow passage 1.

In the microscopic fluid controlling apparatus shown in FIG. 2, plural electromagnets 3 are arranged along to the microscopic flow passage 1 and by varying an electric application the electromagnets 3 are made to work, according to an electromagnetic force the microscopic fluid A, which reacted to the magnetic field, is controlled.

In FIG. 3, from an end portion of the microscopic flow passage 1 such as the micro flow passage or the nano flow passage etc., another microscopic fluid B (a microscopic fluid or a microscopic gaseous body), (a sample microscopic fluid: a following microscopic fluid: a second microscopic fluid plug fluid), which differs from the above stated microscopic fluid A (the driving microscopic fluid), is poured from a downstream of the microscopic fluid A and from a vessel 4 by succeeding the microscopic fluid A with a predetermined space to the microscopic fluid A.

In this case, the microscopic fluid A, which reacts to the electric field, is moved and the microscopic fluid B is flowed into the microscopic flow passage 1 with such move amount. The microscopic fluid B is the sample mic roscopic fluid and is, for example, blood or a reagent.

As shown in FIG. 4, to move the microscopic fluid A (the driving microscopic fluid) in the microscopic fluid to an objected position, the magnet 2 is moved, and by working together another microscopic fluid B (the sample microscopic fluid of the microscopic fluid or the microscopic gaseous body) is moved. Further, in a case where this sample microscopic fluid B is discharged, the microscopic fluid A, which reacts to the electric field, is moved and flown out.

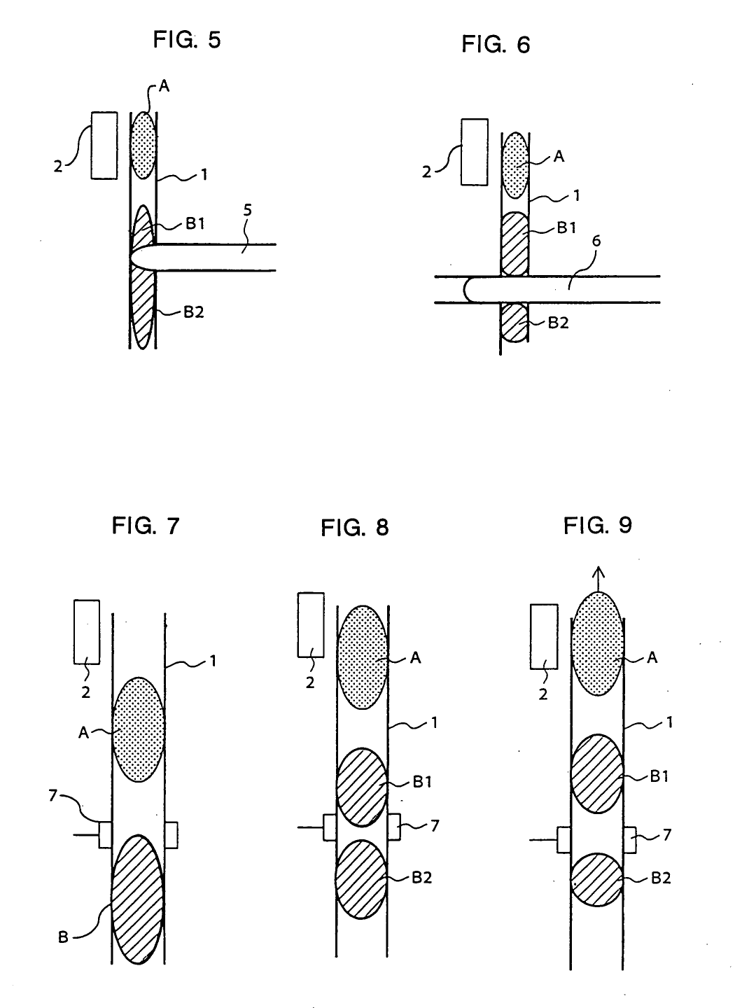

A shape of the microscopic flow passage 1 such as the micro flow passage or the nano flow passage is a single passage, a branch tube shown such as an T shape type branch tube as shown in FIG. 5 and a cross shape type branch tube shown in FIG. 6 or the microscopic flow passage can be formed by the combination thereof. A cross-section of the microscopic flow passage 1 has a round shape, a rectangle shape or a complex shape, and a representative length thereof has an order of a micro-meter order or a nano-meter order.

When a minute control is performed using the branch tube, as shown in FIG. 5, in the microscopic flow passage 1 formed in an T shape type branch tube, a driving microscopic fluid A, which reacts to the electric field or the magnetic field, is moved by positioning it with the magnet 2, and the sample microscopic fluid B to be divided is moved, and the liquid or the gaseous body 5 (a third fluid: such as an inert gas, water and a solution of salt etc.) is poured from the branching portion and the sample microscopic fluid B is divided into, for example, two sample microscopic fluids B1 and B2.

As shown in FIG. 6, the sample microscopic fluid B to be divided is moved to an intersection portion of T shape type branch tube, and another gaseous body and a gaseous body 6 (a third fluid: such as an inert gas, water and a solution of salt etc.) is poured and a flow amount control of the sample microscopic fluid B by dividing into, for example, two sample microscopic fluids B1 and B2.

As shown in FIG. 7, at an outer peripheral portion of the microscopic flow passage 1 such as the micro flow passage or the nano flow passage, a heating portion 7 such as an electrode is provided, the driving microscopic fluid A, which reacts to the electric field and the magnetic field, is moved, and the sample microscopic fluid B is poured.

As shown in FIG. 8, the sample microscopic fluid B is moved by positioning to the heating portion 7 and the electricity is applied to the heating portion 7 by adding the heat, and, for example, a part of the sample microscopic fluid B evaporates, then the sample microscopic fluid B is divided into the two sample microscopic fluids B1 and B2. As shown in FIG. 9, the separated sample microscopic fluids B1 and B are moved further toward to the downstream.

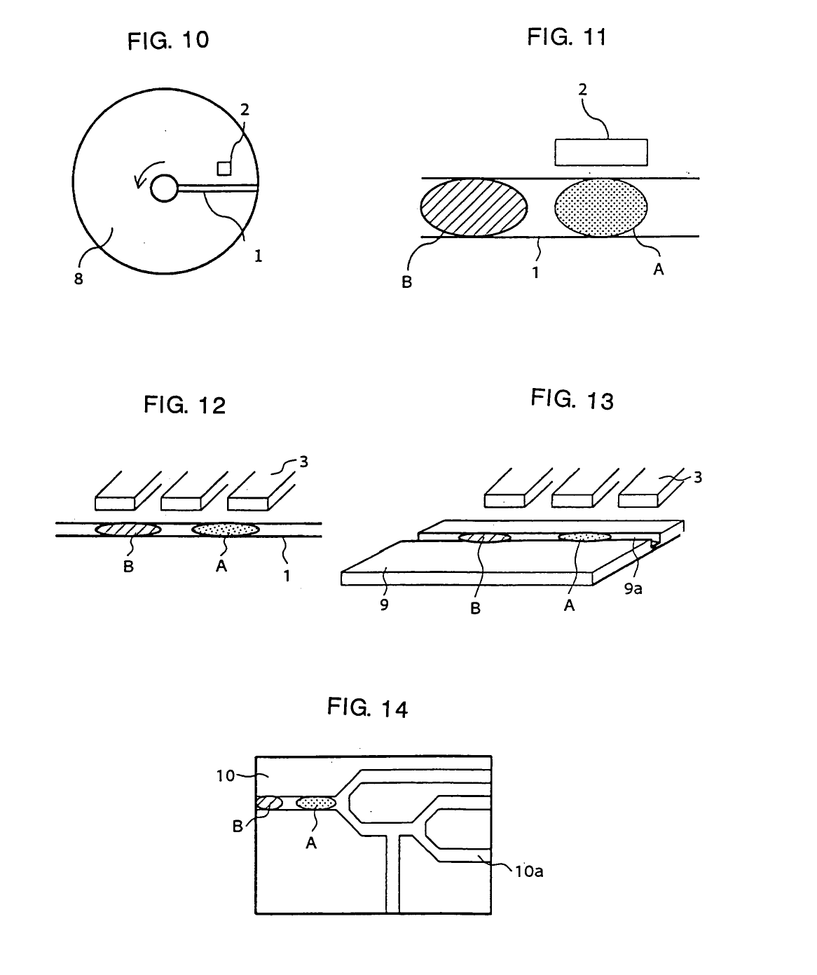

As shown in FIG. 10, on a rotary body (a reactor) 8 the microscopic flow passage 1 such as the micro flow passage or the nano flow passage is mounted, from a central portion the sample microscopic fluid and the sample microscopic gaseous body is flown into the microscopic flow passage 1.

As shown in FIG. 11, an amount (a volume) of the sample microscopic fluid B is controlled according to the driving magnetic fluid A and is flown into the reactor. Further, a flown-into sample microscopic fluid B is diversion-flow controlled. Namely, the sample microscopic fluid B being inhaled in the above stated microscopic flow passage 1 and having a different density is controlled in accordance with the blending and the separation in responsive to the mass.

FIG. 12 is a partial cross-sectional perspective view showing one carrying-out embodiment of the microscopic fluid controlling apparatus according to the present invention, and a flow amount control of the sample microscopic fluid B is carried out using the driving magnetic fluid A, in which plural magnets 3 are arranged at the outer peripheral portion of the microscopic flow passage 1.

FIG. 13 is a perspective view showing one carrying-out embodiment of the microscopic fluid controlling apparatus according to the present invention, and is a perspective view showing the microscopic fluid controlling apparatus in which on an upper portion of a bio-chip (a Lab-on-a-chip) 9 on which a channel-like microscopic flow passage 9a is provided, plural magnets 3 are arranged in parallel and using the magnetic fluid A the flow amount control of the sample microscopic fluid B is carried out.

FIG. 14 is the microscopic fluid controlling apparatus according to the present invention showing a specific shape channel (a microscopic flow passage 10a) used for the microscopic fluid controlling apparatus, which carries out the flow amount control of the sample microscopic fluid B.

The bio-chip 10 having the microscopic flow passage 10a is arranged and using the driving magnetic fluid A the flow amount control of the sample microscopic fluid B is carried out.

An interior portion or a surrounding portion of the microscopic flow passage such as the micro flow passage and the nano flow passage etc. is performed according to an iyophobic treatment, a water repellent treatment, and a water oil treatment, thereby the flow amount control having a high accuracy is carried out.

The devices relating to the microscopic fluid controlling apparatus according to the present invention are a micro-machine, a micro electromechanical system, a small type analyzer (TAS) to which a liquid reagent having a very microscopic amount is reacted, a microchip device, an Lab-on-a-chip (Lab-on-a-chip) such as DNA Lab-chip, a biochip, and a healthcare chip.

According to the present invention, in the interior portion of the microscopic flow passage such as the micro flow passage and the nano flow passage etc., the driving microscopic fluid, which reacts to the electric field and the magnetic field, is putted into, in accordance with the move of the driving microscopic fluid the sample microscopic liquid or the sample microscopic gaseous body is moved in the interior portion of the microscopic flow passage and is positioned.

Further, the inert gas etc. being the third fluid is flown from the branching portion such as T shape type flow passage and the cross shape type flow passage, the sample microscopic fluid to be controlled is divided into and then the flow amount control is carried out.

Accordingly, according to the present invention, the controlling method and the controlling apparatus can provide, in which the inhalation of the sample microscopic fluid into the interior portion of the microscopic flow passage such as the micro flow passage and the nano flow passage etc. and the flow amount control and the quantity amount control of the sample microscopic fluid in the interior portion of the microscopic flow passage.

Utility Possibility in Industry:

The present invention relates to the microscopic fluid controlling method and the microscopic fluid controlling apparatus in which the microscopic fluid having the microscopic amount is treated. The present invention relates to the minute structure device such as the microscopic flow passage manufactured by utilizing the micro processing technique in the integral circuit, the sensor and the actuator etc.

The present invention is used to the chemical analysis in which the liquid reagent having the microscopic amount having the nano-litter order or the micro-litter order, the quantitative component pouring of the microscopic fluid in the fundamental medicines and the fluid control in the micro areas for blending and separating the different kind fluid.

1. A microscopic fluid controlling method comprising the steps of:
moving a first microscopic fluid by changing an electric field or a magnetic field and by positioning said first microscopic fluid in a microscopic flow passage;
inhaling a second microscopic fluid in said microscopic flow passage by succeeding said first microscopic fluid; and
controlling said second microscopic fluid existed in said microscopic flow passage in respective of a move of said first microscopic fluid.

2-7. (canceled)

8. A microscopic fluid controlling apparatus comprising:
a first microscopic fluid moving means for positioning and moving a first microscopic fluid in a microscopic flow passage;
a second microscopic fluid inhaling means for inhaling a second microscopic fluid in said microscopic flow passage by succeeding said first microscopic fluid; and
a controlling means for controlling said second microscopic fluid.

9-11. (canceled)

12. A microscopic fluid controlling method according to claim 1, wherein the microscopic fluid controlling method comprises further the step of:
dividing into plural portions said second microscopic fluid by a third microscopic fluid.

13. A microscopic fluid controlling method according to claim 1, wherein the microscopic fluid controlling method comprises further the step of:
dividing into plural portions said second microscopic fluid by heating.

14. A microscopic fluid controlling method according to claim 1, wherein said second microscopic fluid existing in said microscopic flow passage is controlled by blending and separating said second microscopic fluid according to a mass of said second microscopic fluid.

15. A microscopic fluid controlling method according to claim 1, wherein the microscopic fluid controlling method comprises further the step of:
positioning and moving said first microscopic fluid by changing a magnetic force and an applied electric power.

16. A microscopic fluid controlling method according to claim 12, wherein the microscopic fluid controlling method comprises further the step of:
moving said first microscopic fluid and dividing said second microscopic fluid into plural portions by said third microscopic fluid, by changing a magnetic force and an applied electric power.

17. A microscopic fluid controlling method according to claim 13, wherein said second microscopic fluid is moved to a heating portion by said first microscopic fluid, and by heating said second microscopic fluid existing on said heating portion, and said second microscopic fluid is separated.

18. A microscopic fluid controlling apparatus according to claim 8, further comprising a second microscopic fluid dividing means for dividing into plural portions said second microscopic fluid.

19. A microscopic fluid controlling apparatus according to claim 8, further comprising a second microscopic fluid heating and dividing means that heats said second microscopic fluid and divides said second microscopic fluid.

20. A microscopic fluid controlling apparatus according to claim 8, wherein the microscopic fluid controlling means comprises further:
a rotating means for positioning said first microscopic fluid existing in said microscopic flow passage and moving said first microscopic fluid in said microscopic flow passage; and
second microscopic fluid dividing means for dividing into plural portions said second microscopic fluid; and
a second microscopic fluid blending and separating means for blending and separating said second microscopic fluid.
